(19) United States
(12) Patent Application Publication
(10) Pub. No.: US 2025/0185069 A1
(43) Pub. Date: Jun. 5, 2025

(54) PHYSICAL RANDOM ACCESS CHANNEL TRANSMISSION

(71) Applicant: QUALCOMM Incorporated, San Diego, CA (US)

(72) Inventors: Hung Dinh LY, San Diego, CA (US); Kexin XIAO, Shanghai (CN); Krishna Kiran MUKKAVILLI, San Diego, CA (US)

(21) Appl. No.: 18/842,241

(22) PCT Filed: Apr. 20, 2022
(86) PCT No.: PCT/CN2022/087882

§ 371 Date: Aug. 28, 2024

(51) Int. Cl. H04W 74/0833; H04W 72/0446

(52) U.S. Cl. CPC H04W 74/0833; H04W 72/0446

(57) ABSTRACT

Various aspects of the present disclosure generally relate to wireless communication. In some aspects, a user equipment (UE) may receive one or more synchronization signal blocks (SSBs) associated with a random access channel (RACH) procedure, wherein the one or more SSBs are associated with an uplink physical random access channel (PRACH) transmission in a particular time resource. The UE may receive a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter. Numerous other aspects are described.

### FIELD OF THE DISCLOSURE

Aspects of the present disclosure generally relate to wireless communication and to techniques and apparatuses for physical random access channel transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving one or more synchronization signal blocks (SSBs) associated with a random access channel (RACH) procedure, wherein the one or more SSBs are associated with an uplink physical random access channel (PRACH) transmission in a particular time resource. The method may include receiving a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter.

Some aspects described herein relate to a method of wireless communication performed by a network entity. The method may include transmitting one or more SSBs associated with a RACH procedure, wherein the one or more SSBs are associated with an uplink PRACH transmission in a particular time resource. The method may include transmitting a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter.

Some aspects described herein relate to a UE for wireless communication. The user equipment may include a memory and one or more processors coupled to the memory. The one or more processors may be configured to receive one or more SSBs associated with a RACH procedure, wherein the one or more SSBs are associated with an uplink PRACH transmission in a particular time resource. The one or more processors may be configured to receive a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter.

Some aspects described herein relate to a network entity for wireless communication. The network entity may include a memory and one or more processors coupled to the memory. The one or more processors may be configured to transmit one or more SSBs associated with a RACH procedure, wherein the one or more SSBs are associated with an uplink PRACH transmission in a particular time resource. The one or more processors may be configured to transmit a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter.

Some aspects described herein relate to a non-transitory computer-readable medium that stores a set of instructions for wireless communication by a UE. The set of instructions, when executed by one or more processors of the UE, may cause the UE to receive one or more SSBs associated with a RACH procedure, wherein the one or more SSBs are associated with an uplink PRACH transmission in a particular time resource. The set of instructions, when executed by one or more processors of the UE, may cause the UE to receive a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter.

Some aspects described herein relate to a non-transitory computer-readable medium that stores a set of instructions for wireless communication by a network entity. The set of instructions, when executed by one or more processors of the network entity, may cause the network entity to transmit one or more SSBs associated with a RACH procedure, wherein the one or more SSBs are associated with an uplink PRACH transmission in a particular time resource. The set of instructions, when executed by one or more processors of the network entity, may cause the network entity to transmit a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter.

Some aspects described herein relate to an apparatus for wireless communication. The apparatus may include means for receiving one or more SSBs associated with a RACH procedure, wherein the one or more SSBs are associated with an uplink PRACH transmission in a particular time resource. The apparatus may include means for receiving a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter.

Some aspects described herein relate to an apparatus for wireless communication. The apparatus may include means for transmitting one or more SSBs associated with a RACH procedure, wherein the one or more SSBs are associated with an uplink PRACH transmission in a particular time resource. The apparatus may include means for transmitting a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (O-RAN) architecture, in accordance with the present disclosure.

FIG. 4 is a diagram illustrating an example of physical channels and reference signals in a wireless network, in accordance with the present disclosure.

FIG. 5 is a diagram illustrating an example of a two-step random access procedure, in accordance with the present disclosure.

FIG. 6 is a diagram illustrating an example of a four-step random access procedure, in accordance with the present disclosure.

FIG. 7 is a diagram illustrating an example of a random access procedure with multi-beam synchronization signal blocks, in accordance with the present disclosure.

FIG. 8 is a diagram illustrating an example of a random access response monitoring window, in accordance with the present disclosure.

FIGS. 9A-9F are diagrams illustrating examples associated with physical random access channel transmission, in accordance with the present disclosure.

FIGS. 10-11 are diagrams illustrating example processes associated with physical random access channel transmission, in accordance with the present disclosure.

FIGS. 12-13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

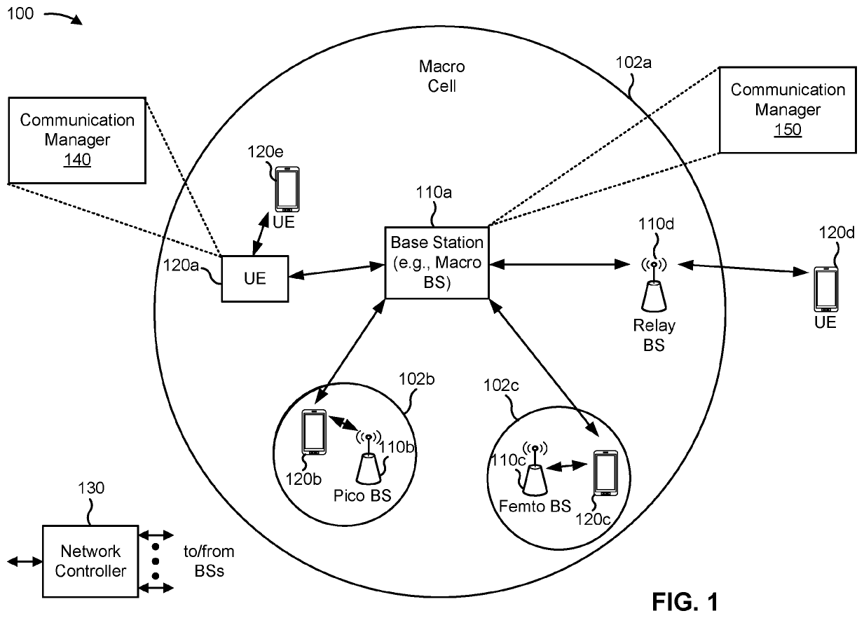

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive one or more synchronization signal blocks (SSBs) associated with a random access channel (RACH) procedure, wherein the one or more SSBs are associated with an uplink physical random access channel (PRACH) transmission in a particular time resource; and receive a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter. Additionally, or alternatively, the communication manager 140 may perform one or more other operations described herein.

In some aspects, a network entity (e.g., the base station 110) may include a communication manager 150. As described in more detail elsewhere herein, the communication manager 150 may transmit one or more SSBs associated with a RACH procedure, wherein the one or more SSBs are associated with an uplink PRACH transmission in a particular time resource; and transmit a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter. Additionally, or alternatively, the communication manager 150 may perform one or more other operations described herein.

As indicated above, FIG. 1 is provided as an example. Other examples may differ from what is described with regard to FIG. 1.

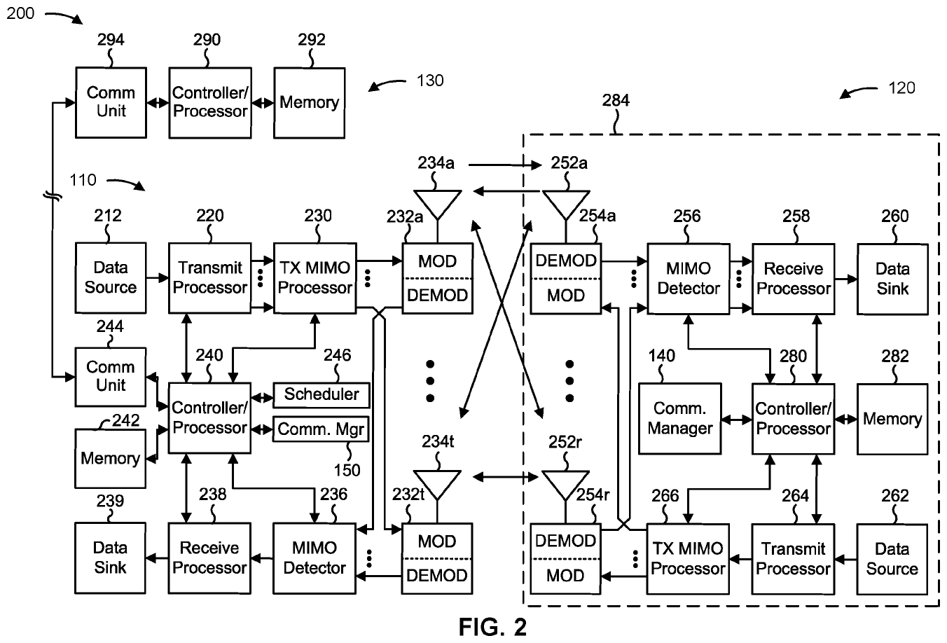

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

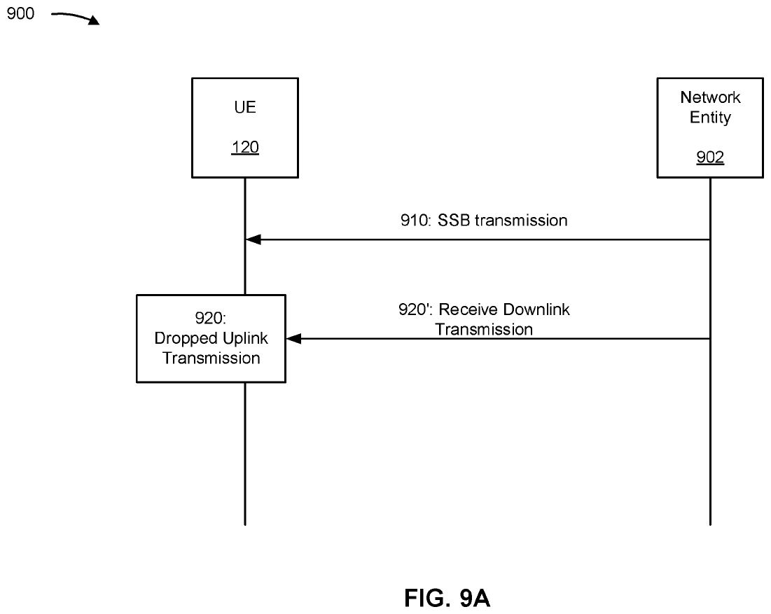

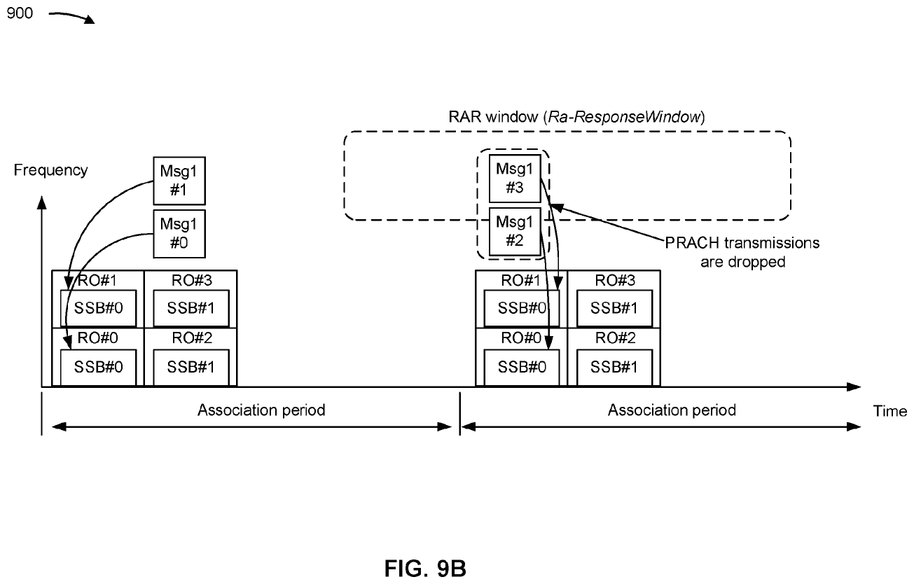

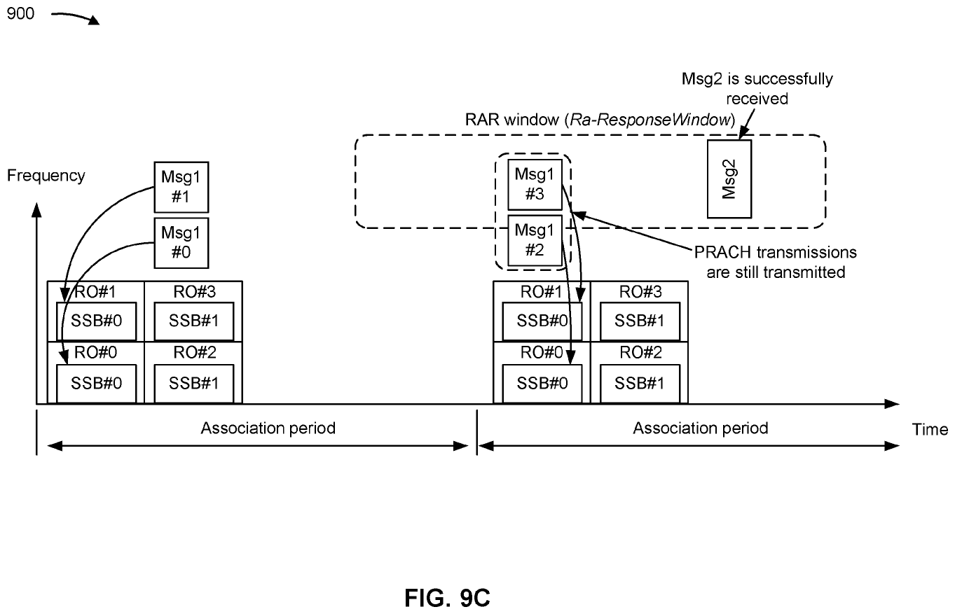

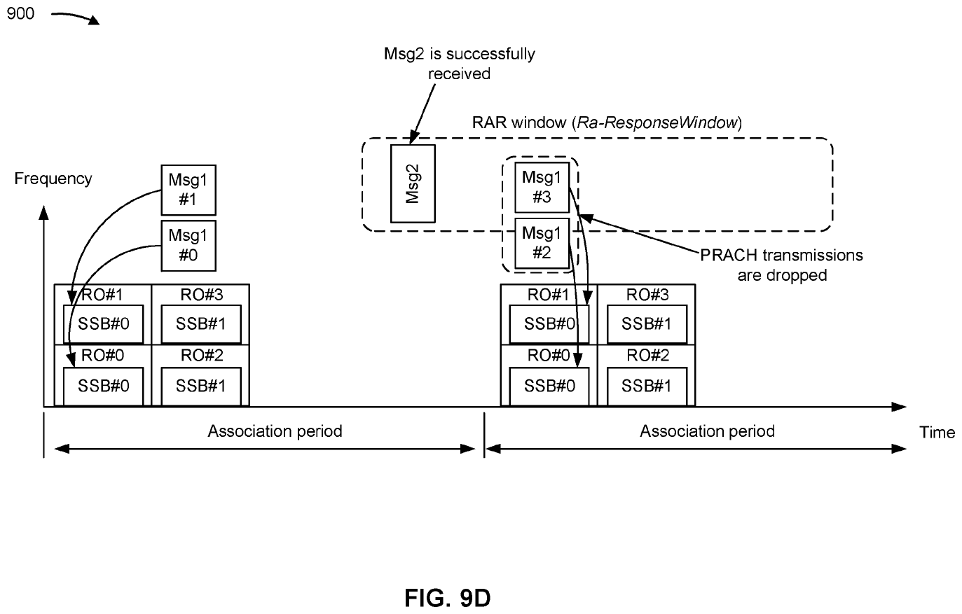

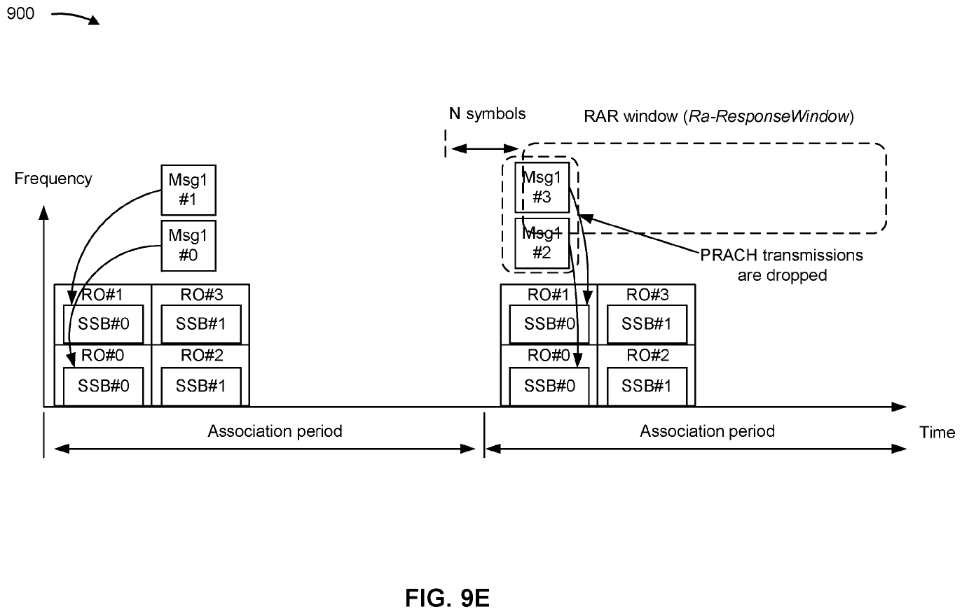

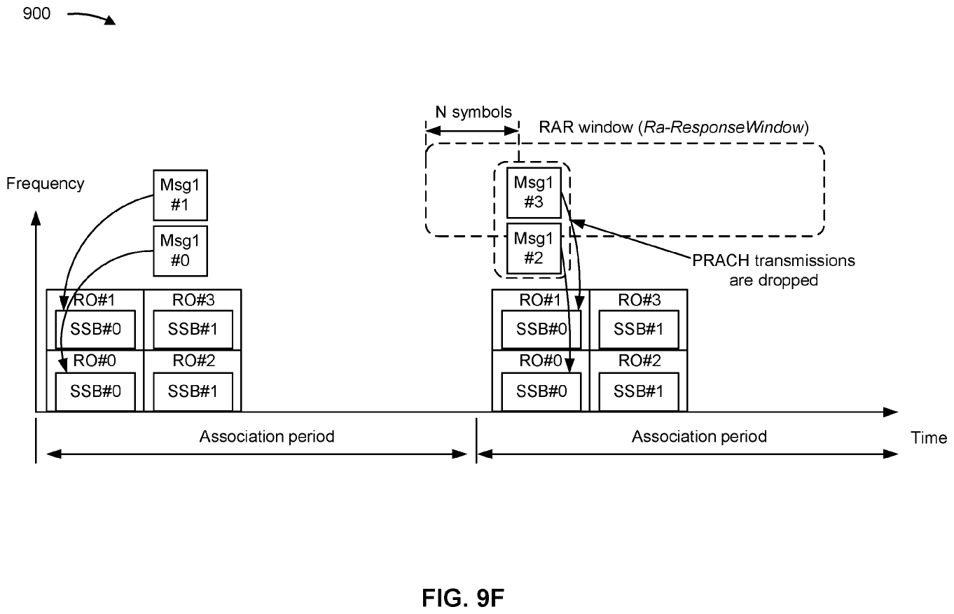

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 9A-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 9A-13).

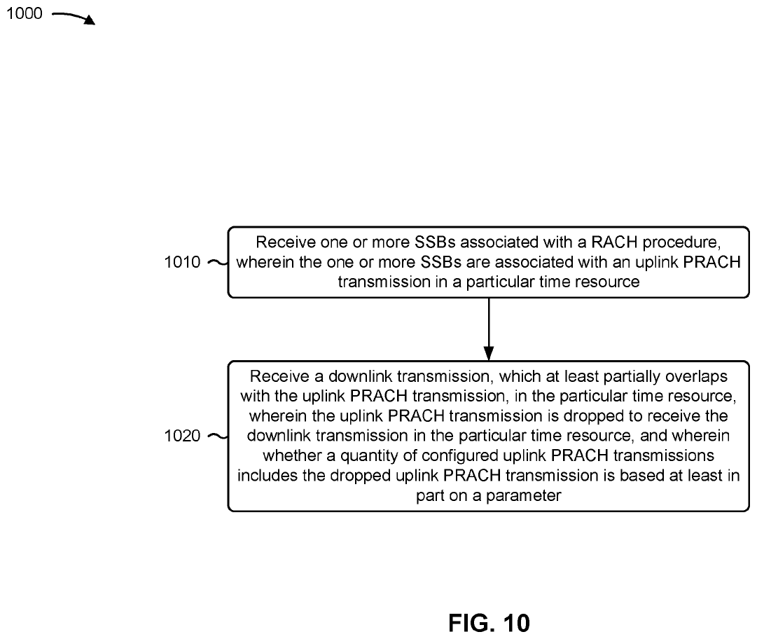

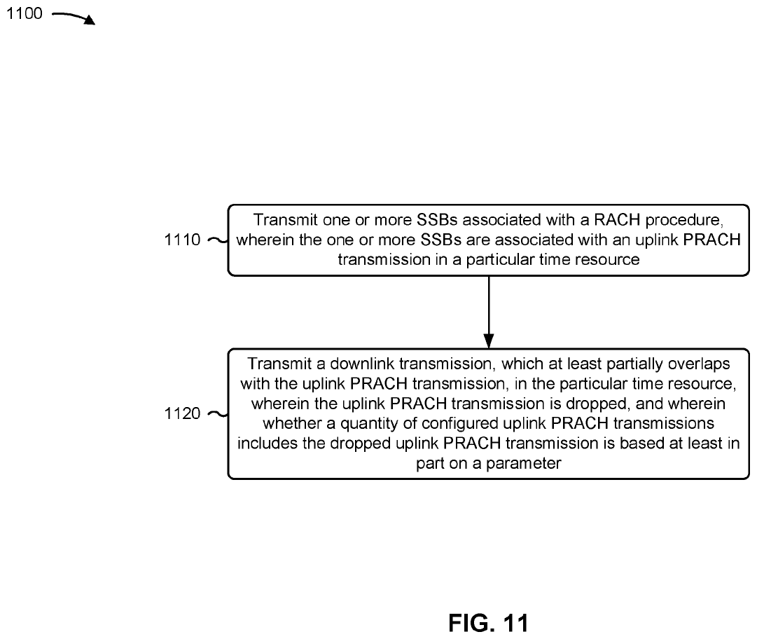

The controller/processor 240 of the base station 110, the controller/processor 280 of the UE 120, and/or any other component(s) of FIG. 2 may perform one or more techniques associated with PRACH transmission, as described in more detail elsewhere herein. In some aspects, the network entity described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving one or more SSBs associated with a RACH procedure, wherein the one or more SSBs are associated with an uplink PRACH transmission in a particular time resource; and/or means for receiving a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., the base station 110) includes means for transmitting one or more SSBs associated with a RACH procedure, wherein the one or more SSBs are associated with an uplink PRACH transmission in a particular time resource; and/or means for transmitting a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

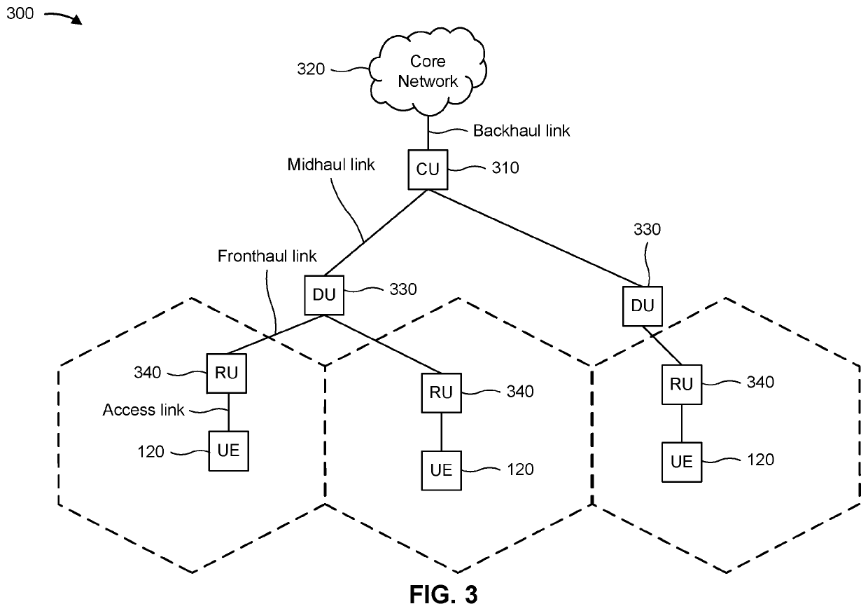

FIG. 3 is a diagram illustrating an example 300 of an open radio access network (O-RAN) architecture, in accordance with the present disclosure. As shown in FIG. 3, the O-RAN architecture may include a central unit (CU) 310 that communicates with a core network 320 via a backhaul link. Furthermore, the CU 310 may communicate with one or more distributed units (DUs) 330 via respective midhaul links. The DUs 330 may each communicate with one or more radio units (RUs) 340 via respective fronthaul links, and the RUs 340 may each communicate with respective UEs 120 via radio frequency (RF) access links. The DUs 330 and the RUs 340 may also be referred to as O-RAN DUS (O-DUs) 330 and O-RAN RUS (O-RUs) 340, respectively.

The DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (ILS-U) interface.

Accordingly, the DU 330 may correspond to a logical unit that includes one or more base station functions to control the operation of one or more RUs 340. For example, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or PRACH extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

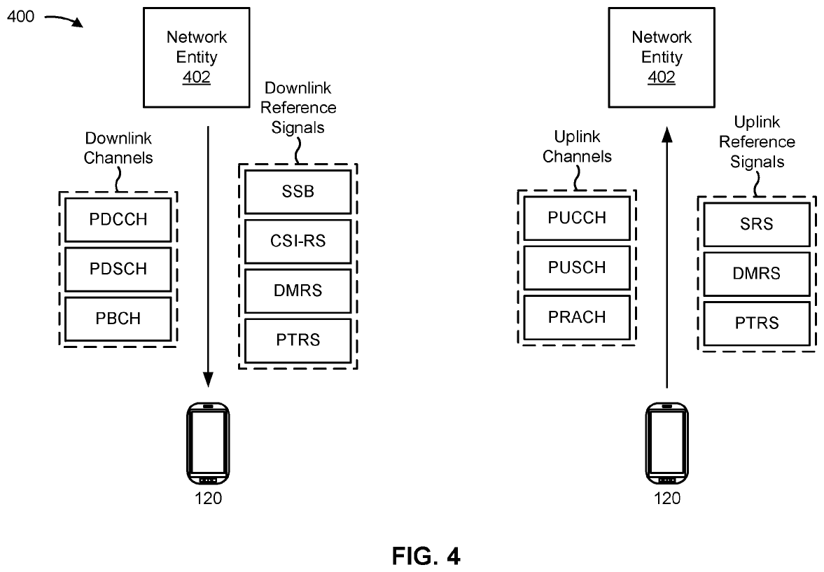

FIG. 4 is a diagram illustrating an example 400 of physical channels and reference signals in a wireless network, in accordance with the present disclosure. As shown in FIG. 4, downlink channels and downlink reference signals may carry information from a network entity 402 to a UE 120, and uplink channels and uplink reference signals may carry information from a UE 120 to a network entity 402.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. The UE 120 may transmit acknowledgement (ACK) or negative acknowledgement (NACK) feedback (e.g, ACK/NACK feedback or ACK/NACK information) in UCI on the PUCCH and/or the PUSCH.

As further shown, a downlink reference signal may include an SSB, a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. The network entity 402 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network entity 402 may configure a set of CSI-RSs for the UE 120, and the UE 120 may measure the configured set of CSI-RSs. Based at least in part on the measurements, the UE 120 may perform channel estimation and may report channel estimation parameters to the network entity 402 (e.g., in a CSI report), such as a CQI, a precoding matrix indicator (PMI), a CSI-RS resource indicator (CRI), a layer indicator (LI), a rank indicator (RI), or an RSRP, among other examples. The network entity 402 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network entity 402 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. The network entity 402 may then calculate a position of the UE 120 based on the RSTD measurements reported by the UE 120.

An SRS may carry information used for uplink channel estimation, which may be used for scheduling, link adaptation, precoder selection, or beam management, among other examples. The network entity 402 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network entity 402 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

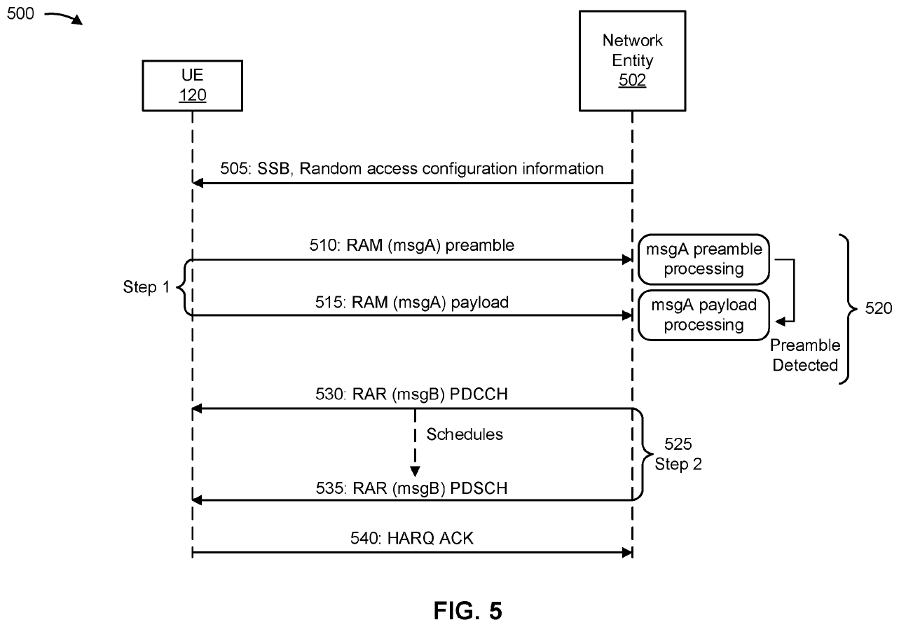

FIG. 5 is a diagram illustrating an example 500 of a two-step random access procedure, in accordance with the present disclosure. As shown in FIG. 5, a network entity 502 and a UE 120 may communicate with one another to perform the two-step random access procedure.

As shown by reference number 505, the network entity 502 may transmit, and the UE 120 may receive, one or more SSBs and random access configuration information. The random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a random access message (RAM) and/or receiving a random access response (RAR) to the RAM.

As shown by reference number 510, the UE 120 may transmit, and the network entity 502 may receive, a RAM preamble. As shown by reference number 515, the UE 120 may transmit, and the network entity 502 may receive, a RAM payload. As shown, the UE 120 may transmit the RAM preamble and the RAM payload to the network entity 502 as part of an initial (or first) step of the two-step random access procedure. The RAM may be referred to as “message A,” “msgA,” a “first message,” or an “initial message” in a two-step random access procedure. Furthermore, the RAM preamble may be referred to as a “message A preamble,” a “msgA preamble,” a “preamble,” or a “PRACH preamble,” and the RAM payload may be referred to as a “message A payload,” a “msgA payload,” or a “payload.” The RAM may include some or all of the contents of message 1 (msg1) and message 3 (msg3) of a four-step random access procedure, which is described in more detail below. For example, the RAM preamble may include some or all contents of message 1 (e.g, a PRACH preamble), and the RAM payload may include some or all contents of message 3 (e.g., a UE identifier, UCI, and/or a PUSCH transmission).

As shown by reference number 520, the network entity 502 may receive the RAM preamble transmitted by the UE 120. If the network entity 502 successfully receives and decodes the RAM preamble, the network entity 502 may then receive and decode the RAM payload.

As shown by reference number 525, the network entity 502 may transmit an RAR (sometimes referred to as an RAR message). As shown, the network entity 502 may transmit the RAR message as part of a second step of the two-step random access procedure. The RAR message may be referred to as “message B,” “msgB,” or a “second message” in a two-step random access procedure. The RAR message may include some or all of the contents of message 2 (msg2) and message 4 (msg4) of a four-step random access procedure, as described in more detail herein. For example, the RAR message may include the detected PRACH preamble identifier, the detected UE identifier, a timing advance value, and/or contention resolution information.

As shown by reference number 530, as part of the second step of the two-step random access procedure, the network entity 502 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 535, as part of the second step of the two-step random access procedure, the network entity 502 may transmit the PDSCH communication for the RAR, as scheduled by the PDCCH communication. The RAR may be included in a MAC protocol data unit (PDU) of the PDSCH communication. As shown by reference number 540, if the UE 120 successfully receives the RAR, the UE 120 may transmit a hybrid automatic repeat request (HARQ) ACK.

As indicated above, FIG. 5 is provided as an example. Other examples may differ from what is described with regard to FIG. 5.

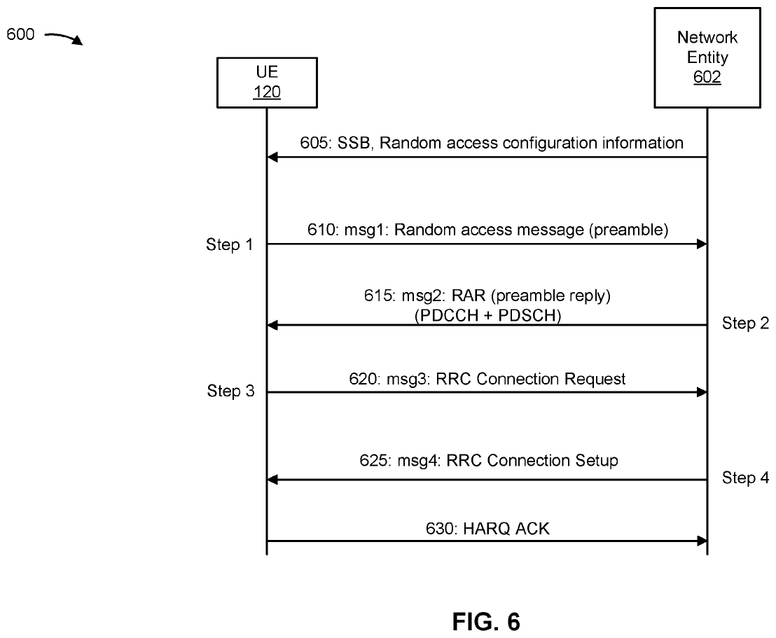

FIG. 6 is a diagram illustrating an example 600 of a four-step random access procedure, in accordance with the present disclosure. As shown in FIG. 6, a network entity 602 and a UE 120 may communicate with one another to perform the four-step random access procedure.

As shown by reference number 605, the network entity 602 may transmit, and the UF 120 may receive, one or more SSBs and random access configuration information. The random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a RAM and/or one or more parameters for receiving an RAR.

As shown by reference number 610, the UE 120 may transmit a RAM, which may include a preamble (sometimes referred to as a random access preamble, a PRACH preamble, or a RAM preamble). The message that includes the preamble may be referred to as a “message 1,” “msg1,” “MSG1,” a “first message,” or an “initial message” in a four-step random access procedure. The random access message may include a random access preamble identifier.

As shown by reference number 615, the network entity 602 may transmit an RAR as a reply to the preamble. The message that includes the RAR may be referred to as “message 2,” “msg2,” “MSG2,” or a “second message” in a four-step random access procedure. The RAR may indicate the detected random access preamble identifier (e.g., received from the UE 120 in msg1). Additionally, or alternatively, the RAR may indicate a resource allocation to be used by the UE 120 to transmit message 3 (msg3).

As part of the second step of the four-step random access procedure, the network entity 602 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network entity 602 may transmit the PDSCH communication for the RAR, as scheduled by the PDCCH communication. The RAR may be included in a MAC PDU of the PDSCH communication.

As shown by reference number 620, the UE 120 may transmit an RRC connection request message. The RRC connection request message may be referred to as “message 3,” “msg3,” “MSG3,” or a “third message” of a four-step random access procedure. The RRC connection request may include a UE identifier, UCI, and/or a PUSCH communication (e.g., an RRC connection request).

As shown by reference number 625, the network entity 602 may transmit an RRC connection setup message. The RRC connection setup message may be referred to as “message 4,” “msg4,” “MSG4,” or a “fourth message” of a four-step random access procedure. The RRC connection setup message may include the detected UE identifier, a timing advance value, and/or contention resolution information. As shown by reference number 630, if the UE 120 successfully receives the RRC connection setup message, the UE 120 may transmit a HARQ ACK.

As indicated above, FIG. 6 is provided as an example. Other examples may differ from what is described with regard to FIG. 6.

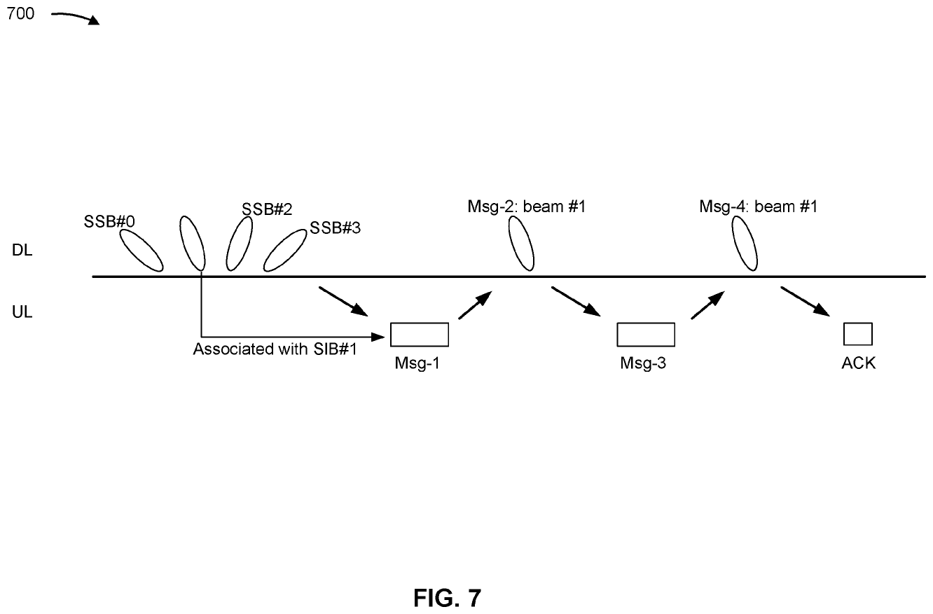

FIG. 7 is a diagram illustrating an example 700 of a RACH procedure with multi-beam SSBs, in accordance with the present disclosure.

As shown in FIG. 7, in a RACH procedure, a network entity (e.g., the network entity 502 or the network entity 602) may transmit a set of SSB beams to a UE (e.g., the UE 120). For example, the UE may receive a first SSB #0, a second SSB #1, a third SSB #2, and a fourth SSB #3, as shown. The UE may determine an SSB to RACH occasion (RO) mapping based at least in part on a SIB received from the network entity. The UE may select an SSB and transmit a PRACH msg1 using a resource associated with the SSB. For example, the UE may select SSB #1 based at least in part on an RSRP and may select a PRACH resource which is associated with SSB #1. Based at least in part on transmitting msg1 using the uplink PRACH resource associated with SSB #1, the network entity may transmit a PDCCH or PDSCH msg2 of the RACH procedure using beam #1, which corresponds to SSB #1. Similarly, the UE may transmit a PUSCH msg3 using a RACH resource associated with SSB #1 and may receive a PDCCH or PDSCH msg4 using beam #1 associated with SSB #1. For example, the UE may transmit msg3 using the same spatial filter that was used to transmit the prior PRACH transmission, msg1.

As indicated above, FIG. 7 is provided as an example. Other examples may differ from what is described with respect to FIG. 7.

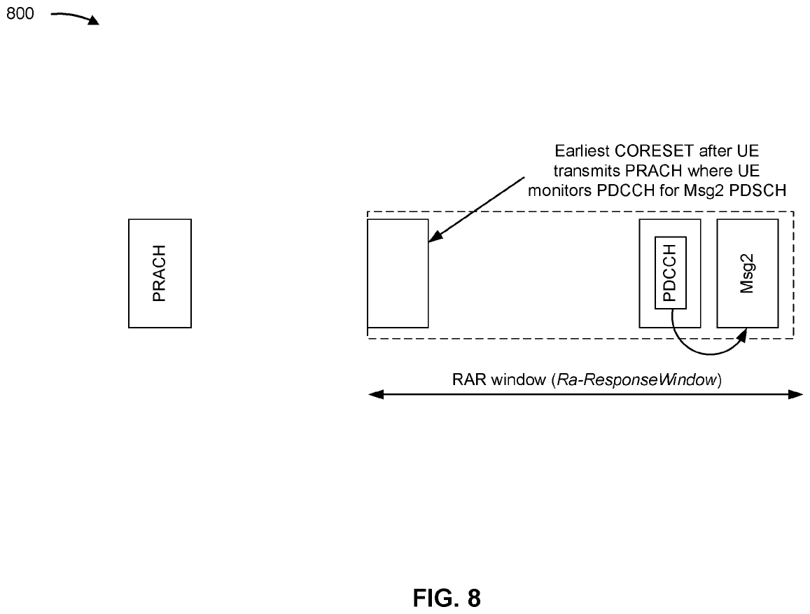

FIG. 8 is a diagram illustrating an example 800 of a RAR monitoring window, in accordance with the present disclosure.

As shown in FIG. 8, after a PRACH transmission (e.g., msg1 of a four step random access procedure), a UE (e.g., the UE 120) may have a RAR window for monitoring for a RAR transmission (e.g., the PDCCH or PDSCH msg2) from a network entity (e.g., the network entity 502 or the network entity 602). The RAR window may start at a first symbol of an earliest control resource set (CORESET) with which the UE is configured to receive a PDCCH for a type-1 PDCCH common search space (CSS) set (e.g., at least one symbol after a last symbol of the uplink PRACH occasion corresponding to the uplink PRACH transmission). A subcarrier spacing (SCS) for a symbol duration for the RAR window corresponds to an SCS for a type-1 PDCCH CSS set. A length of the RAR window (e.g., in slots) is indicated by a parameter ra-Response Window.

As indicated above, FIG. 8 is provided as an example. Other examples may differ from what is described with respect to FIG. 8.

PRACH coverage enhancements have enabled use of multiple PRACH transmissions with the same beams for RACH procedure. When there are multiple PRACH transmissions, some configured PRACH transmissions may overlap with a RAR monitoring window corresponding to some other PRACH transmissions. In other words, a first PRACH transmission may trigger a RAR monitoring window (for receiving a downlink transmission) that overlaps with a PRACH occasion (for transmitting a second PRACH transmission). In such a case, a UE may be unable to concurrently receive the downlink transmission and transmit a PRACH transmission.

Some aspects described herein enable dropping of a PRACH transmission when the uplink PRACH transmission collides with another transmission, such as an SSB transmission or a scheduled downlink transmission. In this case, based at least in part on a parameter received from a network entity, the UE may determine whether to count a dropped PRACH transmission in a quantity of configured PRACH transmissions. In this way, the UE avoids a failure to receive downlink transmissions resulting from attempting to transmit a PRACH transmission on an uplink concurrent with receive the downlink transmissions, thereby improving network performance.

As indicated above, FIG. 8 is provided as an example. Other examples may differ from what is described with respect to FIG. 8.

FIGS. 9A-9F are diagrams illustrating an example 900 of PRACH transmission, in accordance with the present disclosure. As shown in FIG. 9A, example 900 includes a UE 120 and a network entity 902 (e.g., which may correspond to base station 110, CU 310, DU 330, RU 340, network entity 402, network entity 502, or network entity 602, among other examples).

As further shown in FIG. 9A, and by reference number 910, the UE 120 may receive an SSB transmission from the network entity 902. For example, the UE 120 may receive one or more SSBs, which may be associated with a RACH procedure and with triggering an uplink PRACH transmission in a particular uplink resource.

As further shown in FIG. 9A, and by reference numbers 920/920′, the UE 120 may drop an uplink transmission and receive a downlink transmission. For example, the UE 120 may determine that the uplink PRACH transmission, which was triggered by the one or more received SSBs, is in a first time resource that at least partially overlaps with a second time resource for receive a downlink transmission. In this case, the UE 120 may drop (e.g., forgo) transmission of the uplink PRACH transmission and may receive the downlink transmission. In some aspects, the UE 120 may include the dropped PRACH transmission in a count of a quantity of configured PRACH transmissions. For example, the UE 120 may increment a parameter tracking a quantity of configured PRACH transmissions to include the uplink PRACH transmission that was dropped. Additionally, or alternatively, the UE 120 may include the dropped PRACH transmission in the count of the quantity of configured PRACH transmissions. In some aspects, the UE 120 may determine whether to include the dropped PRACH transmission in the count of the quantity of configured PRACH transmissions based at least in part on a received parameter. For example, prior to dropping the uplink PRACH transmission, the UE 120 may receive, from the network entity 902, configuration information including a parameter indicating whether the UE 120 is to include a subsequent dropped uplink PRACH transmission in a count of the quantity of configured PRACH transmissions.

In some aspects, the UE 120 may determine to drop the uplink PRACH transmission based at least in part on the uplink PRACH transmission occurring after a start of a RAR window. For example, as shown in FIG. 9B, msg1 transmissions, triggered by receiving one or more SSBs, are scheduled for a period within a RAR window. In this case, the msg1 transmissions are dropped to enable receipt of downlink transmissions (e.g., another one or more SSBs). In some aspects, the UE 120 may determine to drop the uplink PRACH transmission based at least in part on the UE 120 successfully receiving an msg2 before the uplink PRACH transmission. For example, as shown in FIG. 9C, when the msg1 transmissions are scheduled before receipt of an msg2, the UE 120 can still transmit the msg1 transmissions (even though the msg1 transmissions are scheduled during the RAR window). In contrast, as shown in FIG. 9D, if the msg1 transmissions are scheduled after successful receipt of the msg2, the UE 120 may determine to drop the msg1 transmissions to enable receipt of other downlink transmissions.

In some aspects, the UE 120 may determine to drop the uplink PRACH transmission based at least in part on the uplink PRACH transmission occurring within a threshold quantity of symbols, N, before a start of the RAR window. For example, as shown in FIG. 9E, when the msg1 transmissions are scheduled within a period lasting N symbols before a start of the RAR window, the UE 120 may drop the msg1 transmissions. Similarly, in some aspects, the UE 120 may determine to drop the uplink PRACH transmission based at least in part on the uplink PRACH transmission occurring within a threshold quantity of symbols, N, after a start of the RAR window. For example, as shown in FIG. 9F, when the msg1 transmissions are scheduled within a period lasting N symbols from the start of the RAR window, the UE 120 may drop the msg1 transmissions. In some aspects, the UF 120 may determine a symbol duration (e.g., for the N symbols) based at least in part on a subcarrier spacing of the uplink PRACH transmission. Additionally, or alternatively, the UE 120 may determine the symbol duration based at least in part on an active uplink or downlink bandwidth part on which the UE 120 is communicating or an initial uplink or downlink bandwidth part that the UE 120 used for communication. Additionally, or alternatively, the UE 120 may receive, in a system information (SI) or RRC message, configuration information, from the network entity 902, indicating the subcarrier spacing that the UE 120 is to use for determining the symbol length.

As indicated above, FIGS. 9A-9F are provided as an example. Other examples may differ from what is described with respect to FIGS. 9A-9F.

FIG. 10 is a diagram illustrating an example process 1000 performed, for example, by a UE, in accordance with the present disclosure. Example process 1000 is an example where the UE (e.g., UE 120) performs operations associated with PRACH transmission.

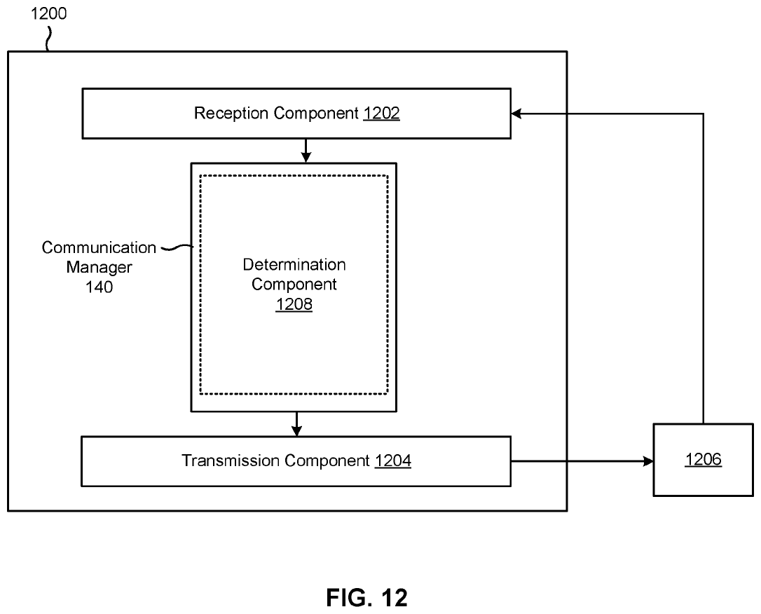

As shown in FIG. 10, in some aspects, process 1000 may include receiving one or more SSBs associated with a RACH procedure, wherein the one or more SSBs are associated with an uplink PRACH transmission in a particular time resource (block 1010). For example, the UE (e.g., using communication manager 140 and/or reception component 1202, depicted in FIG. 12) may receive one or more SSBs associated with a RACH procedure, wherein the one or more SSBs are associated with an uplink PRACH transmission in a particular time resource, as described above.

As further shown in FIG. 10, in some aspects, process 1000 may include receiving a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter (block 1020). For example, the UE (e.g., using communication manager 140 and/or reception component 1202, depicted in FIG. 12) may receive a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter, as described above.

Process 1000 may include additional aspects, such as any single aspect or any combination of aspects described below and/or in connection with one or more other processes described elsewhere herein.

In a first aspect, process 1000 includes receiving configuration information identifying the parameter.

In a second aspect, alone or in combination with the first aspect, the dropped PRACH transmission is included in the quantity of configured PRACH transmissions.

In a third aspect, alone or in combination with one or more of the first and second aspects, the dropped PRACH transmission is not included in the quantity of configured PRACH transmissions.

In a fourth aspect, alone or in combination with one or more of the first through third aspects, the uplink PRACH transmission is dropped based at least in part on the particular time resource being within a random access response window.

In a fifth aspect, alone or in combination with one or more of the first through fourth aspects, process 1000 includes receiving a RACH msg2, wherein the uplink PRACH transmission is dropped based at least in part on the particular time resource being after successful receipt of the RACH msg2.

In a sixth aspect, alone or in combination with one or more of the first through fifth aspects, the uplink PRACH transmission is dropped based at least in part on the particular time resource being within a threshold duration of a start of a random access response window.

In a seventh aspect, alone or in combination with one or more of the first through sixth aspects, the threshold duration is based at least in part on at least one of a subcarrier spacing of the uplink PRACH transmission, a subcarrier spacing of an active uplink bandwidth part, a subcarrier spacing of a downlink bandwidth part, or a received configuration.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., base station 110, CU 310, DU 330, RU 340, network entity 402, network entity 502, or network entity 902, among other examples) performs operations associated with PRACH transmission.

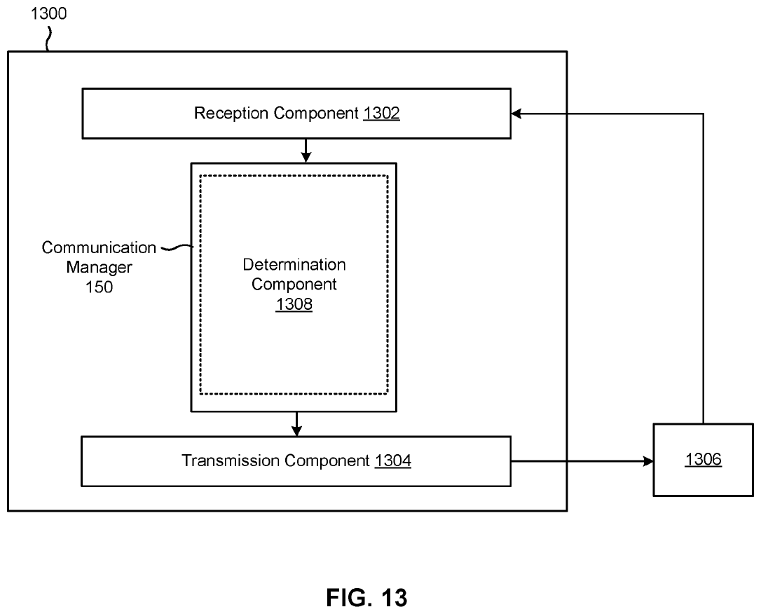

As shown in FIG. 11, in some aspects, process 1100 may include transmitting one or more SSBs associated with a RACH procedure, wherein the one or more SSBs are associated with an uplink PRACH transmission in a particular time resource (block 1110). For example, the base station (e.g., using communication manager 150 and/or transmission component 1304, depicted in FIG. 13) may transmit one or more SSBs associated with a RACH procedure, wherein the one or more SSBs are associated with an uplink PRACH transmission in a particular time resource, as described above.

As further shown in FIG. 11, in some aspects, process 1100 may include transmitting a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter (block 1120). For example, the base station (e.g., using communication manager 150 and/or transmission component 1304, depicted in FIG. 13) may transmit a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter, as described above.

Process 1100 may include additional aspects, such as any single aspect or any combination of aspects described below and/or in connection with one or more other processes described elsewhere herein.

In a first aspect, process 1100 includes transmitting configuration information identifying the parameter.

In a second aspect, alone or in combination with the first aspect, the dropped PRACH transmission is included in the quantity of configured PRACH transmissions.

In a third aspect, alone or in combination with one or more of the first and second aspects, the dropped PRACH transmission is not included in the quantity of configured PRACH transmissions.

In a fourth aspect, alone or in combination with one or more of the first through third aspects, the uplink PRACH transmission is dropped based at least in part on the particular time resource being within a random access response window.

In a fifth aspect, alone or in combination with one or more of the first through fourth aspects, process 1100 includes transmitting a RACH msg2, wherein the uplink PRACH transmission is dropped based at least in part on the particular time resource being after successful receipt of the RACH msg2.

In a sixth aspect, alone or in combination with one or more of the first through fifth aspects, the uplink PRACH transmission is dropped based at least in part on the particular time resource being within a threshold duration of a start of a random access response window.

In a seventh aspect, alone or in combination with one or more of the first through sixth aspects, the threshold duration is based at least in part on at least one of a subcarrier spacing of the uplink PRACH transmission, a subcarrier spacing of an active uplink bandwidth part, a subcarrier spacing of a downlink bandwidth part, or a transmitted configuration.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a determination component 1208, among other examples.

In some aspects, the apparatus 1200 may be configured to perform one or more operations described herein in connection with FIGS. 9A-9F. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive one or more SSBs associated with a RACH procedure, wherein the one or more SSBs are associated with an uplink PRACH transmission in a particular time resource. The reception component 1202 may receive a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter. The reception component 1202 may receive configuration information identifying the parameter. The reception component 1202 may receive a RACH msg2, wherein the uplink PRACH transmission is dropped based at least in part on the particular time resource being after successful receipt of the RACH msg2. The determination component 1208 may determine whether to drop a PRACH transmission.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include a determination component 1308, among other examples.

In some aspects, the apparatus 1300 may be configured to perform one or more operations described herein in connection with FIGS. 9A-9F. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network entity described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network entity described in connection with FIG. 2. In some aspects, the transmission component 1304 may be co-located with the reception component 1302 in a transceiver.

The transmission component 1304 may transmit one or more SSBs associated with a RACH procedure, wherein the one or more SSBs are associated with an uplink PRACH transmission in a particular time resource. The transmission component 1304 may transmit a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter.

The transmission component 1304 may transmit configuration information identifying the parameter. The transmission component 1304 may transmit a RACH msg2, wherein the uplink PRACH transmission is dropped based at least in part on the particular time resource being after successful receipt of the RACH msg2. The determination component 1308 may determine whether to transmit a downlink transmission concurrently with a scheduled uplink PRACH transmission and whether to cause the scheduled uplink PRACH transmission to be dropped.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a user equipment (UE), comprising: receiving one or more synchronization signal blocks (SSBs) associated with a random access channel (RACH) procedure, wherein the one or more SSBs are associated with an uplink physical random access channel (PRACH) transmission in a particular time resource; and receiving a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter.
Aspect 2: The method of Aspect 1, further comprising: receiving configuration information identifying the parameter.
Aspect 3: The method of any of Aspects 1 to 2, wherein the dropped PRACH transmission is included in the quantity of configured PRACH transmissions.
Aspect 4: The method of any of Aspects 1 to 3, wherein the dropped PRACH transmission is not included in the quantity of configured PRACH transmissions.
Aspect 5: The method of any of Aspects 1 to 4, wherein the uplink PRACH transmission is dropped based at least in part on the particular time resource being within a random access response window.
Aspect 6: The method of any of Aspects 1 to 5, further comprising: receiving a RACH message type 2 (msg2), wherein the uplink PRACH transmission is dropped based at least in part on the particular time resource being after successful receipt of the RACH msg2.
Aspect 7: The method of any of Aspects 1 to 6, wherein the uplink PRACH transmission is dropped based at least in part on the particular time resource being within a threshold duration of a start of a random access response window.
Aspect 8: The method of Aspect 7, wherein the threshold duration is based at least in part on at least one of: a subcarrier spacing of the uplink PRACH transmission, a subcarrier spacing of an active uplink bandwidth part, a subcarrier spacing of a downlink bandwidth part, or a received configuration.
Aspect 9: A method of wireless communication performed by a network entity, comprising: transmitting one or more synchronization signal blocks (SSBs) associated with a random access channel (RACH) procedure, wherein the one or more SSBs are associated with an uplink physical random access channel (PRACH) transmission in a particular time resource; and transmitting a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter.
Aspect 10: The method of Aspect 9, further comprising: transmitting configuration information identifying the parameter.
Aspect 11: The method of any of Aspects 9 to 10, wherein the dropped PRACH transmission is included in the quantity of configured PRACH transmissions.
Aspect 12: The method of any of Aspects 9 to 11, wherein the dropped PRACH transmission is not included in the quantity of configured PRACH transmissions.
Aspect 13: The method of any of Aspects 9 to 12, wherein the uplink PRACH transmission is dropped based at least in part on the particular time resource being within a random access response window.
Aspect 14: The method of any of Aspects 9 to 13, further comprising: transmitting a RACH message type 2 (msg2), wherein the uplink PRACH transmission is dropped based at least in part on the particular time resource being after successful receipt of the RACH msg2.
Aspect 15: The method of any of Aspects 9 to 14, wherein the uplink PRACH transmission is dropped based at least in part on the particular time resource being within a threshold duration of a start of a random access response window.
Aspect 16: The method of Aspect 15, wherein the threshold duration is based at least in part on at least one of: a subcarrier spacing of the uplink PRACH transmission, a subcarrier spacing of an active uplink bandwidth part, a subcarrier spacing of a downlink bandwidth part, or a transmitted configuration.
Aspect 17: An apparatus for wireless communication at a device, comprising a processor; memory coupled with the processor; and instructions stored in the memory and executable by the processor to cause the apparatus to perform the method of one or more of Aspects 1-8.
Aspect 18: A device for wireless communication, comprising a memory and one or more processors coupled to the memory, the one or more processors configured to perform the method of one or more of Aspects 1-8.
Aspect 19: An apparatus for wireless communication, comprising at least one means for performing the method of one or more of Aspects 1-8.
Aspect 20: A non-transitory computer-readable medium storing code for wireless communication, the code comprising instructions executable by a processor to perform the method of one or more of Aspects 1-8.
Aspect 21: A non-transitory computer-readable medium storing a set of instructions for wireless communication, the set of instructions comprising one or more instructions that, when executed by one or more processors of a device, cause the device to perform the method of one or more of Aspects 1-8.
Aspect 22: An apparatus for wireless communication at a device, comprising a processor; memory coupled with the processor; and instructions stored in the memory and executable by the processor to cause the apparatus to perform the method of one or more of Aspects 9-16.
Aspect 23: A device for wireless communication, comprising a memory and one or more processors coupled to the memory, the one or more processors configured to perform the method of one or more of Aspects 9-16.
Aspect 24: An apparatus for wireless communication, comprising at least one means for performing the method of one or more of Aspects 9-16.
Aspect 25: A non-transitory computer-readable medium storing code for wireless communication, the code comprising instructions executable by a processor to perform the method of one or more of Aspects 9-16.
Aspect 26: A non-transitory computer-readable medium storing a set of instructions for wireless communication, the set of instructions comprising one or more instructions that, when executed by one or more processors of a device, cause the device to perform the method of one or more of Aspects 9-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive one or more synchronization signal blocks (SSBs) associated with a random access channel (RACH) procedure, wherein the one or more SSBs are associated with an uplink physical random access channel (PRACH) transmission in a particular time resource; and
receive a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter.

2. The UE of claim 1, wherein the one or more processors are further configured to:
receive configuration information identifying the parameter.

3. The UE of claim 1, wherein the dropped PRACH transmission is included in the quantity of configured PRACH transmissions.

4. The UE of claim 1, wherein the dropped PRACH transmission is not included in the quantity of configured PRACH transmissions.

5. The UE of claim 1, wherein the uplink PRACH transmission is dropped based at least in part on the particular time resource being within a random access response window.

6. The UE of claim 1, wherein the one or more processors are further configured to:
receive a RACH message type 2 (msg2), wherein the uplink PRACH transmission is dropped based at least in part on the particular time resource being after successful receipt of the RACH msg2.

7. The UE of claim 1, wherein the uplink PRACH transmission is dropped based at least in part on the particular time resource being within a threshold duration of a start of a random access response window.

8. The UE of claim 1, wherein the threshold duration is based at least in part on at least one of:
a subcarrier spacing of the uplink PRACH transmission,
a subcarrier spacing of an active uplink bandwidth part,
a subcarrier spacing of a downlink bandwidth part, or
a received configuration.

9. A network entity for wireless communication, comprising:
a memory; and
one or more processors, coupled to the memory, configured to:
transmit one or more synchronization signal blocks (SSBs) associated with a random access channel (RACH) procedure, wherein the one or more SSBs are associated with an uplink physical random access channel (PRACH) transmission in a particular time resource; and
transmit a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter.

10. The network entity of claim 9, wherein the one or more processors are further configured to:
transmit configuration information identifying the parameter.

11. The network entity of claim 9, wherein the dropped PRACH transmission is included in the quantity of configured PRACH transmissions.

12. The network entity of claim 9, wherein the dropped PRACH transmission is not included in the quantity of configured PRACH transmissions.

13. The network entity of claim 9, wherein the uplink PRACH transmission is dropped based at least in part on the particular time resource being within a random access response window.

14. The network entity of claim 9, wherein the one or more processors are further configured to:
transmit a RACH message type 2 (msg2), wherein the uplink PRACH transmission is dropped based at least in part on the particular time resource being after successful receipt of the RACH msg2.

15. The network entity of claim 9, wherein the uplink PRACH transmission is dropped based at least in part on the particular time resource being within a threshold duration of a start of a random access response window.

16. The network entity of claim 15, wherein the threshold duration is based at least in part on at least one of:
a subcarrier spacing of the uplink PRACH transmission,
a subcarrier spacing of an active uplink bandwidth part,
a subcarrier spacing of a downlink bandwidth part, or
a transmitted configuration.

17. A method of wireless communication performed by a user equipment (UE), comprising:
receiving one or more synchronization signal blocks (SSBs) associated with a random access channel (RACH) procedure, wherein the one or more SSBs are associated with an uplink physical random access channel (PRACH) transmission in a particular time resource; and
receiving a downlink transmission, which at least partially overlaps with the uplink PRACH transmission, in the particular time resource, wherein the uplink PRACH transmission is dropped to receive the downlink transmission in the particular time resource, and wherein whether a quantity of configured PRACH transmissions includes the dropped PRACH transmission is based at least in part on a parameter.

18. The method of claim 17, further comprising:
receiving configuration information identifying the parameter.

19. The method of claim 17, wherein the dropped PRACH transmission is included in the quantity of configured PRACH transmissions.

20. The method of claim 17, wherein the dropped PRACH transmission is not included in the quantity of configured PRACH transmissions.

21. The method of claim 17, wherein the uplink PRACH transmission is dropped based at least in part on the particular time resource being within a random access response window.

22. The method of claim 17, further comprising:
receiving a RACH message type 2 (msg2), wherein the uplink PRACH transmission is dropped based at least in part on the particular time resource being after successful receipt of the RACH msg2.

23. The method of claim 17, wherein the uplink PRACH transmission is dropped based at least in part on the particular time resource being within a threshold duration of a start of a random access response window.

24. The method of claim 23, wherein the threshold duration is based at least in part on at least one of:
a subcarrier spacing of the uplink PRACH transmission,
a subcarrier spacing of an active uplink bandwidth part,
a subcarrier spacing of a downlink bandwidth part, or
a received configuration.

25. A method of wireless communication performed by a network entity, comprising:
transmitting one or more synchronization signal blocks (SSBs) associated with a random access channel (RACH) procedure, wherein the one or more SSBs are associated with an uplink physical random access channel (PRACH) transmission in a particular time resource; and
transmitting a downlink transmission, which at least partially overlaps with the uplink PRACH transmission, in the particular time resource, wherein the uplink PRACH transmission is dropped, and wherein whether a quantity of configured PRACH transmissions includes the dropped PRACH transmission is based at least in part on a parameter.

26. The method of claim 25, further comprising:
transmitting configuration information identifying the parameter.

27. The method of claim 25, wherein the dropped PRACH transmission is included in the quantity of configured PRACH transmissions.

28. The method of claim 25, wherein the dropped PRACH transmission is not included in the quantity of configured PRACH transmissions.

29. The method of claim 25, wherein the uplink PRACH transmission is dropped based at least in part on the particular time resource being within a random access response window.

30. The method of claim 25, further comprising:
transmitting a RACH message type 2 (msg2), wherein the uplink PRACH transmission is dropped based at least in part on the particular time resource being after successful receipt of the RACH msg2.
